(19) United States
(12) Patent Application Publication
(10) Pub. No.: US 2025/0026960 A1
(43) Pub. Date: Jan. 23, 2025

(54) POLISHING SLURRY COMPOSITION

(71) Applicant: KCTECH CO.,LTD., Gyeonggi-do (KR)

(72) Inventors: Bo Hyeok CHOI, Gyeonggi-do (KR); Hyun Goo KONG, Gyeonggi-do (KR); Ji Hye KIM, Gyeonggi-do (KR)

(73) Assignee: KCTECH CO.,LTD., Gyeonggi-do (KR)

(21) Appl. No.: 18/715,108

(22) PCT Filed: Dec. 1, 2022
(86) PCT No.: PCT/KR2022/019314

§ 371 Date: May 30, 2024

(30) Foreign Application Priority Data
Dec. 23, 2021 (KR) 10-2021-0186546

(51) Int. Cl. C09G 1/02

(52) U.S. Cl. CPC C09G 1/02

(57) ABSTRACT

The present invention relates to a polishing slurry composition, and more specifically to a polishing slurry composition for polysilicon polishing, the composition comprising: colloidal silica abrasive particles; a quaternary ammonium cationic monomer; and an acidic material.

### TECHNICAL FIELD

The present disclosure relates to a polishing slurry composition for a chemical mechanical polishing (CMP) process of a polycrystalline silicon film.

### BACKGROUND ART

A chemical mechanical polishing (CMP) process refers to a process of flatly polishing a surface of a semiconductor wafer using a slurry containing an abrasive and various compounds through a rotation movement while the surface of the semiconductor wafer is in contact with a polishing pad. In general, it is known that a metal polishing process is performed by repeating a process of forming a metal oxide (MOₓ) by an oxidizing agent and a process of removing the formed metal oxide with abrasive particles.

As semiconductor devices become more diversified and highly integrated, techniques of forming finer patterns are being used, and accordingly a surface structure of semiconductor devices becomes more complicated and a step height of surface films also becomes greater. A CMP process is used as a planarization technique for removing a stepped portion of a specific film formed on a wafer in manufacturing of a semiconductor device. A CMP composition is selective in removing one type of integrated circuit component relative to another component. Compositions and methods for CMP of wafer surfaces are well known in the art. A CMP slurry composition for polishing of a surface of a semiconductor wafer typically includes abrasive particles, various additive compounds, and the like. Flash memory devices (three-dimensional (3D) flash memory) with 3D transistor stacks are increasingly popular. Polishing slurries for 3D flash applications need to generally provide high polishing rates of polycrystalline silicon, a polishing selectivity of silicon oxide, as well as good surface topography, low defect levels, and the like. In addition, it is necessary to overcome limitations of a polishing slurry composition on securing of a high polishing rate of a polycrystalline silicon film, which is possible in an alkaline region only.

### DISCLOSURE OF THE INVENTION

### Technical Goals

To solve the above-described problems, the present disclosure relates to a polishing slurry composition for polishing a polycrystalline silicon film, which may realize high polishing performance of polycrystalline silicon, for example, high polishing performance in an acidic region.

However, goals to be achieved are not limited to those described above, and other goals not mentioned above can be clearly understood by one of ordinary skill in the art from the following description.

### Technical Solutions

According to an embodiment of the present disclosure, there is provided a polishing slurry composition for polishing of polysilicon, including colloidal silica abrasive particles; a quaternary ammonium cationic monomer; and an acidic material.

According to an embodiment of the present disclosure, the colloidal silica abrasive particles may have cationic surface charges. The colloidal silica abrasive particles may include single-sized particles with a size of 10 nanometers (nm) to 200 nm, or a mixture of two or more particles with different sizes of 10 nm to 200 nm.

According to an embodiment of the present disclosure, the abrasive particles may be in an amount of 0.0001% by weight (wt %) to 10 wt % in the slurry composition.

According to an embodiment of the present disclosure, the quaternary ammonium cationic monomer may include at least one of compounds represented by the following Chemical Formulae 1 to 3.

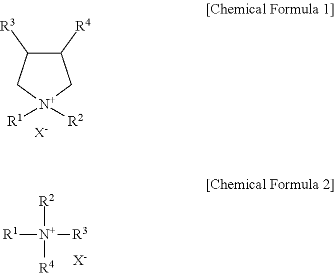

(in Chemical Formula 1, R¹ to R⁴ are each selected from a linear or branched alkyl group having 1 to 50 carbon atoms, a linear or branched alkenyl group having 2 to 50 carbon atoms, and a linear or branched alkoxyl group having 1 to 50 carbon,
in Chemical Formula 2, R¹ to R⁴ are each selected from hydrogen, a linear or branched alkyl group having 1 to 50 carbon atoms, a linear or branched alkenyl group having 2 to 50 carbon atoms and a linear or branched alkoxyl group having 1 to 50 carbon, and an aromatic ring having 6 to 30 carbon atoms, and
in Chemical Formulae 1 and 2, X is a counter ion and is selected from hydroxide (OH⁻), halogen, sulfate (SO₄²⁻), phosphate (PO₄³⁻), nitrate (NO₃⁻), hydrogen sulfate (HSO₄⁻), methyl methanesulfonate (CH₃SO₃⁻), perchlorate (ClO₄⁻), and hexafluorophosphate (PF₆⁻).)

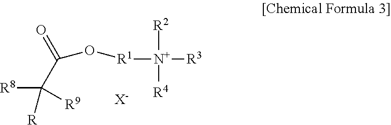

(in Chemical Formula 3, R, R⁸, and R⁹ are each selected from hydrogen, a linear or branched alkyl group having 1 to 50 carbon atoms, a linear or branched alkenyl group having 2 to 50 carbon atoms and a linear or branched alkoxyl group having 1 to 50 carbon, and an aromatic ring having 6 to 30 carbon atoms,
R¹ is selected from a linear or branched alkylene group having 1 to 50 carbon atoms and

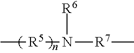

(R⁵ and R⁷ are each a linear or branched alkylene group having 1 to 50 carbon atoms, R⁶ is hydrogen, a linear or branched alkyl group having 1 to 50 carbon atoms; or a linear or branched alkenyl group having 2 to 50 carbon atoms, and n is 0 or 1),
R² to R⁴ are each selected from hydrogen, a linear or branched alkyl group having 1 to 50 carbon atoms, a linear or branched alkenyl group having 2 to 50 carbon atoms, and an aromatic ring with 6 to 30 carbon atoms, and
X is a counter ion and is selected from hydroxide (OH⁻), halogen, sulfate (SO₄²⁻), phosphate (PO₄³⁻), nitrate (NO₃⁻), hydrogen sulfate (HSO₄⁻), or methyl methanesulfonate (CH₃SO₃⁻), perchlorate (ClO₄⁻), and hexafluorophosphate (PF₆⁻).)

According to an embodiment of the present disclosure, in Chemical Formula 1, R¹ to R⁴ may be each selected from a linear or branched alkyl group having 1 to 10 carbon atoms.

According to an embodiment of the present disclosure, in Chemical Formula 2, R² to R⁴ may be each selected from a linear or branched alkyl group having 1 to 10 carbon atoms, and in Chemical Formula 2, at least one of R⁸ to R⁹ may be hydrogen.

According to an embodiment of the present disclosure, the quaternary ammonium cationic monomer may be in an amount of 0.0001 wt % to 0.5 wt % in the composition.

According to an embodiment of the present disclosure, the acidic material may include an inorganic acid, an organic acid, or both, and the acidic material may be in an amount of 0.0001 wt % to 1 wt % in the polishing slurry composition.

According to an embodiment of the present disclosure, the inorganic acid may include at least one selected from a group consisting of a sulfuric acid, a nitric acid, a phosphoric acid, a silicic acid, a hydrofluoric acid, a boric acid, a bromic acid, an iodic acid, a hydrochloric acid, and a perchloric acid.

According to an embodiment of the present disclosure, the organic acid may include a monocarboxylic acid, a dicarboxylic acid, or both. The organic acid may include at least one selected from a group consisting of a citric acid, an oxalic acid, a propionic acid, a stearic acid, a pyruvic acid, an acetic acid, an acetoacetic acid, a glyoxylic acid, a malic acid, a malonic acid, a dimethylmalonic acid, a maleic acid, a glutaric acid, an adipic acid, a 2-methyladipic acid, a trimethyl adipic acid, a pimelic acid, a phthalic acid, a trimellitic acid, a tartaric acid, a glycollic acid, a 2,2-dimethylglutaric acid, a lactic acid, isoleucine, a butyric acid, a succinic acid, a 3,3-diethylsuccinic acid, and an ascorbic acid.

According to an embodiment of the present disclosure, when two or more acidic materials are applied as the acidic material, a mass ratio of a first acidic material: the remaining acidic materials may range from 9:1 to 1:9.

According to an embodiment of the present disclosure, the polishing slurry composition may further include a basic compound, and the basic compound may include at least one selected from a group consisting of ammonia, ammonium methyl propanol (AMP), tetra methyl ammonium hydroxide (TMAH), ammonium hydroxide, potassium hydroxide, sodium hydroxide, magnesium hydroxide, rubidium hydroxide, cesium hydroxide, sodium bicarbonate, sodium carbonate, imidazole, monoethanolamine (MEA), diethanol amine (DEA), triethanolamine (TEA), 1,5-diamino-3-pentanol, 2-dimethylamino-2-methyl-1-propanol, 1-amino-2-propanol, 1-dimethylamino-2-propanol, 1,3-diamino-2-propanol, 3-dimethylamino-1-propanol, 2-amino-1-propanol, 2-dimethylamino-1-propanol, 2-diethylamino-1-propanol, 2-(2-aminoethylamino) ethanol, 2-diethylamino-1-ethanol, 2-ethylamino-1-ethanol, 1-(dimethylamino) 2-propanol, N-methyldiethaolamine, N-propyldiethaolamine, N-isopropyldiethaolamine, N-(2-methylpropyl) diethaolamine, N-n-butyldiethaolamine, N-t-butylethanolamine, N-cyclohexyldiethaolamine, 2-(dimethylamino) ethanol, 2-diethylaminoethanol, 2-dipropylaminoethanol, 2-butylaminoethanol, 2-t-butylaminoethanol, 2-cycloaminoethanol, 2-amino-2-pentanol, 2-[bis(2-hydroxyethyl)amino]-2-methyl-1-propanol, 2-[bis(2-hydroxyethyl)amino]-2-propanol, N,N-bis(2-2-amino-2-methyl-1-propanol, hydroxypropyl) ethanolamine, tris(hydroxymethyl)aminomethane, triisopropanolamine, tetraethyl ammonium hydroxide (TEAH), tetrapropylammonium hydroxide (TPAH), tetrabutylammonium hydroxide, tetrapentylammonium hydroxide (TBAH), methyl(trishydroxyethyl) ammonium hydroxide, tributylethylammonium hydroxide, (2-hydroxyethyl), triethylammonium hydroxide, (2-hydroxyethyl)tripropylammonium hydroxide, and (1-hydroxypropyl)trimethylammonium hydroxide.

According to an embodiment of the present disclosure, pH of the slurry composition may range from 2 to 11.

According to an embodiment of the present disclosure, a polishing speed of the polishing slurry composition for a polycrystalline silicon film may be 2000 Å/min or greater.

According to an embodiment of the present disclosure, in pH of 3 to 5 or pH of 9 to 11 of the polishing slurry composition, a selectivity of a polycrystalline silicon film: a film comprising a silicon nitride film, a silicon oxide film, or both may range from 10:1 to 1000:1.

### Effects of the Invention

The present disclosure may provide a polishing slurry composition that may secure a high polishing rate and improve polishing performance, and for example, may secure a high polishing rate of a polycrystalline silicon film in both a basic region and an acidic region and realize a good polishing selectivity for another film, such as a nitride film, an oxide film, and the like.

### BEST MODE FOR CARRYING OUT THE INVENTION

Hereinafter, detailed description will be provided with reference to embodiments of the present disclosure. However, various alterations and modifications may be made to the embodiments, and the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not intended to be limiting. The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, components, and/or combinations thereof, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

In the description of embodiments, detailed description of well-known related structures or functions will be omitted when it is deemed that such description will cause ambiguous interpretation of the present disclosure.

In addition, the terms first, second, A, B, (a), and (b) may be used to describe components of the embodiments. These terms are used only for the purpose of discriminating one component from another component, and the nature, the sequences, or the orders of the components are not limited by the terms. It should be noted that if it is described in the specification that one component is “connected,” “coupled,” or “joined” to another component, the former may be directly “connected,” “coupled,” and “joined” to the latter or “connected,” “coupled,” and “joined” to the latter via another component.

Components included in one embodiment and components having a common function will be described using the same names in other embodiments. Unless otherwise mentioned, the descriptions on the embodiments may be applicable to the following embodiments and thus, duplicated descriptions will be omitted for conciseness.

Hereinafter, embodiments of the present disclosure will be described in detail. In the description of the present disclosure, detailed description of well-known related functions or configurations will be omitted when it is deemed that such description will cause ambiguous interpretation of the present disclosure. In addition, the terminologies used herein are for the purpose of appropriately describing embodiments of the present disclosure, and may vary depending on the intention of users or operators or customs in the art to which the present disclosure belongs. Therefore, terms used herein should be defined based on the content throughout the present specification.

In the whole specification, when one member is positioned “on” another member, this not only includes a case that the one member is brought into contact with the other member, but also includes a case that another member exists between two members.

It will be understood throughout the whole specification that, when one part “includes” or “comprises” one component, the part does not exclude other components but may further include the other components.

Hereinafter, a polishing slurry composition according to the present disclosure will be described in detail with reference to embodiments. However, the present disclosure is not limited to the embodiments.

The present disclosure relates to a polishing slurry composition, and according to an embodiment of the present disclosure, the polishing slurry composition may include colloidal silica abrasive particles; a quaternary ammonium cationic monomer; and an acidic material.

According to an embodiment of the present disclosure, the colloidal silica abrasive particles may include particles with a size of 10 nanometers (nm) to 200 nm, or 20 nm to 200 nm. When the size of the colloidal silica abrasive particles is within the above ranges, a desired polishing rate may be secured and excessive polishing caused by an increase in the size may be prevented. For example, the abrasive particles may include single-sized particles with the size of 10 nm to 200 nm, or a mixture of two or more particles with different sizes of 10 nm to 200 nm. For example, the abrasive particles may include a first particle with a size of 10 nm to 50 nm and a second particle with a size of greater than 50 nm to 100 nm, and a mixing ratio (mass ratio) of the first particle: the second particle may range from 1:0.1 to 10. The size may be a diameter, a length, a thickness, and the like, depending on the shape of particles. For example, the size of the abrasive particles may be a diameter, a radius, a maximum length, and the like, depending on the shape of particles. An average particle diameter of the abrasive particles may be an average value of particle diameters of a plurality of particles within a visual range that may be measured by XRD, SEM, TEM, BET, or dynamic light scattering. For example, the first particle, which is a particle formed initially in a synthesis reaction, may include non-agglomerated particles, and a plurality of first particles may aggregate with each other to form a second particle. When the size of the first particle is less than the above ranges, the polishing rate may decrease, and when the size of the first particle exceeds the above ranges, uniformity may deteriorate. In addition, when the size of the second particle is less than the above ranges, the polishing rate may decrease, or small particles may be generated due to milling, which may result in a decrease in cleanability and an occurrence of excessive defects on a surface of a wafer. When the size of the second particle exceeds the above ranges, excessive polishing may occur, which May result in dishing, erosion, and surface defects.

In an example of the present disclosure, the colloidal silica abrasive particles may include a single particle with a specific surface area of 30 (m²/g) to 150 (m²/g), or a mixture of particles with different specific surface areas of 30 (m²/g) to 150 (m²/g). For example, the abrasive particles may include a first particle with a specific surface area of 30 (m²/g) to 80 (m²/g), and a second particle with a specific surface area of greater than 80 (m²/g) to 150 (m²/g), and a mixing ratio (mass ratio) of the first particle: the second particle may range from 1:0.1 to 10. When the specific surface area of the colloidal silica abrasive particles is within the above ranges, a sufficient area of a portion in contact with a target film to be polished may be secured to provide a relatively high polishing speed, and an occurrence of scratches and dishing on a surface of the target film to be polished may be reduced. The specific surface area may be measured by a Brunauer-Emmett-Teller (BET) method. For example, the specific surface area may be measured by a BET 6-point method via a nitrogen gas adsorption-flow method using a porosimetry analyzer (Bell Japan Inc, Belsorp-II mini).

In an example of the present disclosure, the colloidal silica abrasive particles may include at least one selected from a group consisting of a spherical shape, a rectangular shape, a needle shape, and a plate shape.

In an example of the present disclosure, the colloidal silica abrasive particles may exhibit cationic surface charges due to surface substitution, coating with an organic material and/or an inorganic material, or both. In addition, the colloidal silica abrasive particles may control silica surface charges based on the type of substituents on surfaces of silica particles, for example, substitution with cations such as NH₃⁺, or a control of a density (or the number) of substituents. For example, the cationic surface charges of the colloidal silica abrasive particles may exhibit positive zeta potentials of 8 millivolts (mV) or greater; 10 mV or greater; 15 mV or greater; or 40 mV or greater in pH of 1 to 6 in a liquid carrier.

In an example of the present disclosure, the colloidal silica abrasive particles may be included in an amount of 0.0001% by weight (wt %) to 10 wt % %; 0.001 wt % to 10 wt %; or 0.1 wt % to 10 wt % in the slurry composition. When the amount of the colloidal silica abrasive particles is within the above ranges, a desired polishing rate may be realized depending on a target film to be polished (e.g., a polycrystalline silicon film), and/or a desired selectivity may be realized by controlling a polishing rate, the number of abrasive particles remaining on a surface of a target film to be polished (e.g., a polycrystalline silicon film) according to an increase in an amount of abrasive particles may be reduced, and a reduction in a polishing speed due to a low amount and an occurrence of secondary defects, such as dishing or erosion in a pattern, due to excessive polishing may be prevented.

According to an embodiment of the present disclosure, the quaternary ammonium cationic monomer may include at least one of compounds represented by Chemical Formula 1, Chemical Formula 2, and Chemical Formula 3 shown below. For example, the quaternary ammonium cationic monomer may include a hydrophobic group and a hydrophilic group formed by an aliphatic hydrocarbon chain (C-Chain) to assist in achieving a high polishing rate during polishing of polycrystalline silicon.

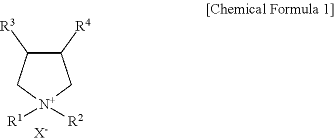

In an example of the present disclosure, in Chemical Formula 1, R¹, R², R³, and R⁴ may be each selected from a linear or branched alkyl group having 1 to 50 carbon atoms, a linear or branched alkenyl group having 2 to 50 carbon atoms, and a linear or branched alkoxyl group having 1 to 50 carbon atoms.

In an example of the present disclosure, in Chemical Formula 1, the X may be a counter ion and may be selected from hydroxide (OH⁻), halogen, sulfate (SO₄²⁻), phosphate (PO₄³⁻), nitrate (NO₃⁻), hydrogen sulfate (HSO₄⁻), methyl methanesulfonate (CH₃SO₃⁻), perchlorate (ClO₄⁻), and hexafluorophosphate (PF₆⁻). The alkoxyl group may be represented by —O—R′, and R′ may be selected from a linear or branched alkyl group having 1 to 50 carbon atoms and a linear or branched alkenyl group having 2 to 50 carbon atoms.

In an example of the present disclosure, the “number of carbon atoms” of alkyl in Chemical Formula 1 may be each selected from a range of 1 to 50; 1 to 30; 1 to 20; 1 to 10; or 1 to 3.

In an example of the present disclosure, the “number of carbon atoms” of alkenyl in Chemical Formula 2 may be each selected from a range of 2 to 50; 2 to 30; 2 to 20; 2 to 10; or 2 to 3.

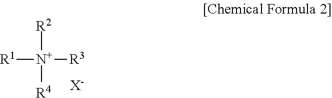

In an example of the present disclosure, in Chemical Formula 2, R¹, R², R³, and R⁴ may be each selected from hydrogen, a linear or branched alkyl group having 1 to 50 carbon atoms, a linear or branched alkenyl group having 2 to 50 carbon atoms and a linear or branched alkoxyl group having 1 to 50 carbon, and an aromatic ring having 6 to 30 carbon atoms, the alkoxyl group may be represented by —O—R′, and R′ may be selected from a linear or branched alkyl group having 1 to 50 carbon atoms and a linear or branched alkenyl group having 2 to 50 carbon atoms.

Desirably, in Chemical Formula 2, R¹, R², R³, and R⁴ may be each selected from hydrogen, a linear or branched alkyl group having 1 to 50 carbon atoms, a linear or branched alkenyl group having 2 to 50 carbon atoms, and an aromatic ring having 6 to 30 carbon atoms, and all R¹, R², R³, and R⁴ are not hydrogen.

In an example of the present disclosure, in Chemical Formula 2, the X may be a counter ion and may be selected from hydroxide (OH⁻), halogen, sulfate (SO₄²⁻), phosphate (PO₄³⁻), nitrate (NO₃⁻), hydrogen sulfate (HSO₄⁻) or methyl methanesulfonate (CH₃SO₃⁻), perchlorate (ClO₄⁻), and hexafluorophosphate (PF₆⁻).

In an example of the present disclosure, the “number of carbon atoms” of alkyl in Chemical Formula 2 may be each selected from a range of 1 to 50; 1 to 30; 1 to 20; 1 to 10; or 1 to 3.

In an example of the present disclosure, the “number of carbon atoms” of alkenyl in Chemical Formula 2 may be each selected from a range of 2 to 50; 2 to 30; 2 to 20; 2 to 10; or 2 to 3.

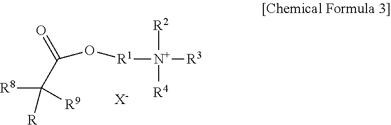

In an example of the present disclosure, in Chemical Formula 3, R, R⁸, and R⁹ may be each selected from hydrogen, a linear or branched alkyl group having 1 to 50 carbon atoms, a linear or branched alkenyl group having 2 to 50 carbon atoms and a linear or branched alkoxyl group having 1 to 50 carbon, and an aromatic ring having 6 to 30 carbon atoms, the alkoxyl group may be represented by —O—R′, and R′ may be selected from a linear or branched alkyl group having 1 to 50 carbon atoms and a linear or branched alkenyl group having 2 to 50 carbon atoms. Desirably, in Chemical Formula 2, R, R⁸, and R⁹ may be each selected from a linear or branched alkyl group having 1 to 50 carbon atoms, a linear or branched alkenyl group having 2 to 50 carbon atoms, and a linear or branched alkoxyl group having 1 to 50 carbon atoms.

In an example of the present disclosure, in Chemical Formula 3, R¹ may be selected from a linear or branched alkylene group having 1 to 50 carbon atoms and

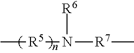

(R⁵ and R⁷ are each a linear or branched alkylene group having 1 to 50 carbon atoms, R⁶ is hydrogen, a linear or branched alkyl group having 1 to 50 carbon atoms; or a linear or branched alkenyl group having 2 to 50 carbon atoms, and n is 0 or 1).

In an example of the present disclosure, in Chemical Formula 3, R² to R⁴ may be each selected from hydrogen, a linear or branched alkyl group having 1 to 50 carbon atoms, a linear or branched alkenyl group having 2 to 50 carbon atoms, and an aromatic ring having 6 to 30 carbon atoms.

In an example of the present disclosure, in Chemical Formula 3, the X may be a counter ion and may be selected from hydroxide (OH⁻), halogen, sulfate (SO₄²⁻), phosphate (PO₄³⁻), nitrate (NO₃⁻), hydrogen sulfate (HSO₄⁻) or methyl methanesulfonate (CH₃SO₃⁻), perchlorate (ClO₄⁻), and hexafluorophosphate (PF₆⁻).

In an example of the present disclosure, the “number of carbon atoms” of alkyl in Chemical Formula 3 may be each selected from a range of 1 to 50; 1 to 30; 1 to 20; 1 to 10; or 1 to 3. Desirably, in Chemical Formula 2, at least one of R⁸ and R⁹ may be hydrogen.

In an example of the present disclosure, the “number of carbon atoms” of alkenyl in Chemical Formula 3 may be each selected from a range of 2 to 50; 2 to 30; 2 to 20; 2 to 10; or 2 to 3.

In an example of the present disclosure, the quaternary ammonium cationic monomer may include at least one selected from a group consisting of dimethyldimethylammonium chloride, dimethyldiethylammonium chloride, dimethyldipropylammonium chloride, dimethyldioctylammonium chloride, dimethyldialkylammonium chloride, diethyldialkylammonium chloride, distearyldimethylammonium chloride, diallyldimethylammonium chloride (DADMAC), diallyldiethylammonium chloride, trimethyloctylammonium chloride, 2-trialkylammonioethyl methacrylate (e.g., 2-trimethylammonioethyl methacrylate chloride), and 2-(trialkylamino)ethyl acrylate (e.g., 2-(trimethylamino)ethyl acrylate, 2-(dimethylamino)ethyl acrylate, methyl chloride quaternary salt).

In an example of the present disclosure, the quaternary ammonium cationic monomer may be in an amount of 0.0001 wt % to 0.5 wt % in the polishing slurry composition. When the amount of the quaternary ammonium cationic monomer is within the above range, a high polishing rate may be realized when a polycrystalline silicon film is polished, for example, it may be possible to obtain an effect of realizing a high polishing rate for a polycrystalline silicon film in an acidic region.

According to an embodiment of the present disclosure, the acidic material may assist in improving a function of a pH adjustor of the polishing slurry composition, a dispersion stability of colloidal silica particles, and polishing performance of polycrystalline silicon, and may include, for example, an inorganic acid, an organic acid, or both.

In an example of the present disclosure, the inorganic acid may include at least one selected from a group consisting of a sulfuric acid, a nitric acid, a phosphoric acid, a silicic acid, a hydrofluoric acid, a boric acid, a bromic acid, an iodic acid, a hydrochloric acid, and a perchloric acid.

In an example of the present disclosure, the organic acid may include a monocarboxylic acid, a dicarboxylic acid, or both. The organic acid may include at least one selected from a group consisting of a citric acid, an oxalic acid, a propionic acid, a stearic acid, a pyruvic acid, an acetic acid, an acetoacetic acid, a glyoxylic acid, a malic acid, a malonic acid, a dimethylmalonic acid, a maleic acid, a glutaric acid, an adipic acid, a 2-methyladipic acid, a trimethyl adipic acid, a pimelic acid, a phthalic acid, a trimellitic acid, a tartaric acid, a glycollic acid, a 2,2-dimethylglutaric acid, a lactic acid, isoleucine, a butyric acid, a succinic acid, a 3,3-diethylsuccinic acid, and an ascorbic acid.

In an example of the present disclosure, the acidic material may be in an amount of 0.0001 wt % to 3 wt %; 0.001 wt % to 1 wt %; or 0.01 wt % to 1 wt % in the polishing slurry composition. When the amount of the acidic material is included in the above ranges, it may be advantageous to obtain an effect of increasing a chemical mechanical polishing (CMP) amount of polycrystalline silicon due to an increase in the amount of the acidic material, and when two or more types of acidic materials are applied as the acidic material, a mass ratio of a first acidic material to the remaining acidic materials may range from 9:1 to 1:9, to assist in improving a polishing selectivity of polycrystalline silicon.

According to an embodiment of the present disclosure, the polishing slurry composition may further include a basic compound. In an example of the present disclosure, the basic compound may assist in improving the function of the pH adjustor, the dispersion stability of colloidal silica particles, and the polishing performance of polycrystalline silicon, and may include at least one selected from a group consisting of ammonia, ammonium methyl propanol (AMP), tetra methyl ammonium hydroxide (TMAH), ammonium hydroxide, potassium hydroxide, sodium hydroxide, magnesium hydroxide, rubidium hydroxide, cesium hydroxide, sodium bicarbonate, sodium carbonate, imidazole, monoethanolamine (MEA), diethanol amine (DEA), triethanolamine (TEA), 1,5-diamino-3-pentanol, 2-dimethylamino-2-methyl-1-propanol, 1-amino-2-propanol, 1-dimethylamino-2-propanol, 1,3-diamino-2-propanol, 3-dimethylamino-1-propanol, 2-amino-1-propanol, 2-dimethylamino-1-propanol, 2-diethylamino-1-propanol, 2-(2-aminoethylamino) ethanol, 2-diethylamino-1-ethanol, 2-ethylamino-1-ethanol, 1-(dimethylamino) 2-propanol, N-methyldiethaolamine, N-propyldiethaolamine, N-isopropyldiethaolamine, N-(2-methylpropyl) diethaolamine, N-n-butyldiethaolamine, N-t-butylethanolamine, N-cyclohexyldiethaolamine, 2-(dimethylamino) ethanol, 2-diethylaminoethanol, 2-dipropylaminoethanol, 2-butylaminoethanol, 2-t-butylaminoethanol, 2-cycloaminoethanol, 2-amino-2-pentanol, 2-[bis(2-hydroxyethyl)amino]-2-methyl-1-propanol, 2-[bis(2-hydroxyethyl)amino]-2-propanol, N, N-bis(2-hydroxypropyl) ethanolamine, 2-amino-2-methyl-1-propanol, tris(hydroxymethyl)aminomethane, triisopropanolamine, tetraethyl ammonium hydroxide (TEAH), tetrapropylammonium hydroxide (TPAH), tetrabutylammonium hydroxide, tetrapentylammonium hydroxide (TBAH), methyl(trishydroxyethyl) ammonium hydroxide, tributylethylammonium hydroxide, (2-hydroxyethyl), triethylammonium hydroxide, (2-hydroxyethyl) tripropylammonium hydroxide, and (1-hydroxypropyl) trimethylammonium hydroxide.

In an example of the present disclosure, the basic compound may be in an amount of 0.0001 wt % to 3 wt %; 0.001 wt % to 1 wt % or 0.01 wt % to 1.0 wt % in the polishing slurry composition, and when the amount of the basic compound is included in the above ranges, it may be advantageous to obtain an effect of increasing a CMP amount of polycrystalline silicon.

According to an embodiment of the present disclosure, the polishing slurry composition may have pH of 2 to 11, for example, pH of 3 to 5 or pH of 9 to 11. In an acidic region with pH of 3 to 5, the polishing slurry composition may realize high polishing performance of a polycrystalline silicon film and dispersion stability. In addition, when a highly basic region is formed out of the pH ranges, significant separation of a semiconductor material may occur after polishing, and accordingly, a roughness of a surface of a substrate to be polished, for example, a wafer, may not be constant, and defects such as dishing, erosion, erosion, corrosion, and surface imbalance may occur.

According to an embodiment of the present disclosure, the polishing slurry composition may be applied to polishing of a substrate including a polycrystalline silicon film, and may be applied to, for example, a CMP process of a substrate including a polycrystalline silicon film.

According to an embodiment of the present disclosure, the polishing slurry composition may have a positive zeta potential, and may have, for example, a zeta potential of 1 mV to 100 mV; 10 mV to 80 mV; or 20 mV to 60 mV. When the zeta potential of the polishing slurry composition is within the above ranges, a polishing speed of a hydrophobic polycrystalline silicon film may be enhanced.

According to an embodiment of the present disclosure, the polishing slurry composition may exhibit a negative zeta potential in an alkaline region, and may have, for example, a zeta potential of −1 mV or less; −10 mV or less; −30 mV or less; or −30 mV to −100 mV.

According to an embodiment of the present disclosure, when a polishing process is performed on a substrate including the polycrystalline silicon film using the polishing slurry composition, a polishing speed for the polycrystalline silicon film may be 2000 Å/min or greater; 3000 Å/min or greater, and may be, for example, in a range of 2000 Å/min to 5000 Å/min.

According to an embodiment of the present disclosure, when a polishing process is performed on a substrate including the polycrystalline silicon film, and a film including a silicon nitride film, a silicon oxide film or both using the polishing slurry composition, a high polishing selectivity of the polycrystalline silicon film may be realized, and for example, in pH of 3 to 5 or pH of 9 to 11 of the polishing slurry composition, a selectivity of a polycrystalline silicon film: a film including a silicon nitride film, a silicon oxide film, or both may range from 10:1 to 3000:1.

Hereinafter, the present disclosure will be described in detail with reference to examples. However, the following examples are illustrative only, and do not limit the scope of the present disclosure.

### Example 1

According to Table 1 shown below, colloidal silica (the size of 60 nm to 80 nm) with a cationic surface charge, a quaternary ammonium cationic monomer (diallyldimethylammonium chloride), and a nitric acid as a pH adjuster were mixed until pH reached 4, to prepare a polishing slurry composition.

### Example 2

According to Table 1 shown below, colloidal silica (the size of 60 nm to 80 nm) with a cationic surface charge, a quaternary ammonium cationic monomer (diallyldimethylammonium chloride), and a nitric acid as a pH adjuster were mixed until pH reached 4, to prepare a polishing slurry composition.

### Example 3

According to Table 1 shown below, colloidal silica (the size of 60 nm to 80 nm) with a cationic surface charge, a quaternary ammonium cationic monomer (diallyldimethylammonium chloride), and a nitric acid as a pH adjuster were mixed until pH reached 4, to prepare a polishing slurry composition.

### Example 4

According to Table 1 shown below, colloidal silica (the size of 60 nm to 80 nm) with a cationic surface charge, a quaternary ammonium cationic monomer (diallyldimethylammonium chloride), and a nitric acid as a pH adjuster were mixed until pH reached 4, to prepare a polishing slurry composition.

### Example 5

According to Table 1 shown below, colloidal silica (the size of 60 nm to 80 nm) with a cationic surface charge, a quaternary ammonium cationic monomer (diallyldimethylammonium chloride), and a nitric acid as a pH adjuster were mixed until pH reached 4, to prepare a polishing slurry composition.

### Example 6

According to Table 1 shown below, colloidal silica (the size of 60 nm to 80 nm) with a cationic surface charge, a quaternary ammonium cationic monomer (diallyldimethylammonium chloride), and a nitric acid as a pH adjuster were mixed until pH reached 4, to prepare a polishing slurry composition.

### Example 7

According to Table 1 shown below, colloidal silica (the size of 30 nm to 40 nm) with a cationic surface charge, a quaternary ammonium cationic monomer (diallyldimethylammonium chloride), and a nitric acid as a pH adjuster were mixed until pH reached 4, to prepare a polishing slurry composition.

### Example 8

According to Table 1 shown below, colloidal silica (the size of 10 nm to 20 nm) with a cationic surface charge, a quaternary ammonium cationic monomer (diallyldimethylammonium chloride), and a nitric acid as a pH adjuster were mixed until pH reached 4, to prepare a polishing slurry composition.

### Example 9

According to Table 1 shown below, colloidal silica (the size of 10 nm to 20 nm) with a cationic surface charge, a quaternary ammonium cationic monomer (diallyldimethylammonium chloride), and potassium hydroxide (KOH) as a pH adjuster were mixed until pH reached 11, to prepare a polishing slurry composition.

### Example 10

According to Table 1 shown below, colloidal silica (the size of 60 nm to 80 nm) with a cationic surface charge, a quaternary ammonium cationic monomer (trimethyloctylammonium chloride), and a nitric acid as a pH adjuster were mixed until pH reached 4, to prepare a polishing slurry composition.

### Example 11

According to Table 1 shown below, colloidal silica (the size of 60 nm to 80 nm, F-2 or G-1) with a cationic surface charge, a quaternary ammonium cationic monomer (trimethyloctylammonium chloride), and a nitric acid as a pH adjuster were mixed until pH reached 4, to prepare a polishing slurry composition.

### Comparative Example 1

A polishing slurry composition was prepared in the same manner as in Example 1, except that a nitrogen-based nonionic compound (acrylamide) was added based on Table 1.

### Comparative Example 2

A polishing slurry composition was prepared in the same manner as in Example 1, except that a quaternary ammonium cationic monomer was not added based on Table 1.

### Comparative Example 3

According to Table 1 shown below, colloidal silica (the size of 60 nm to 80 nm) with a cationic surface charge, a cationic polymer (poly(2-vinylpyridine) (P2VP)), and a nitric acid as a pH adjuster were mixed until pH reached 4, to prepare a polishing slurry composition.

### Comparative Example 4

According to Table 1 shown below, colloidal silica (the size of 60 nm to 80 nm) with a cationic surface charge, a cationic polymer (polyethyleneimine (PEI)), and a nitric acid as a pH adjuster were mixed until pH reached 4, to prepare a polishing slurry composition.

### Comparative Example 5

According to Table 1 shown below, colloidal silica (the size of 60 nm to 80 nm) with a cationic surface charge, an anionic polymer (polyacrylic acid (PAA)), and a nitric acid as a pH adjuster were mixed until pH reached 4, to prepare a polishing slurry composition.

### Comparative Example 6

According to Table 1 shown below, colloidal silica (the size of 60 nm to 80 nm) with a cationic surface charge, a nonionic polymer (polyethylene glycol (PEG)), and a nitric acid as a pH adjuster were mixed until pH reached 4, to prepare a polishing slurry composition.

### Comparative Example 7

According to Table 1 shown below, colloidal silica (the size of 30 nm to 40 nm) with a cationic surface charge, a nonionic polymer (polyethylene glycol (PEG)), and a nitric acid as a pH adjuster were mixed until pH reached 4, to prepare a polishing slurry composition.

### Evaluation of Polishing Characteristics

A substrate containing a polysilicon film was polished using the polishing slurry compositions of the examples and comparative examples under the following polishing conditions.

### [Polishing Conditions]

(1) Polishing machine: ST #01 (KCT)
(2) Carrier rpm/Platen rpm: 87/93
(3) Wafer Pressure: 3 psi
(4) Surry Flow rate (ml/min): 250 ml/min
(5) Pad: IC 1000
(6) Time: 60 s
(7) R-ring pressure: 6 psi

To evaluate polishing characteristics, a polysilicon wafer substrate was polished using the polishing slurry compositions of the examples and comparative examples, and then a polishing speed and a recess of a pattern surface after polishing were measured, and results thereof are shown in Table 1.

TABLE 1

| | | | | | | Polishing | | |
|---|---|---|---|---|---|---|---|---|
| | Colloidal | | | | | amount | Polishing | Polishing |
| | silica | | | | | of Poly- | amount | amount |
| | particles | | Additive-1 | | | Si | of nitride | of oxide |
| | Type | Wt % | Type | Wt % | pH | (Å/min) | (Å/min) | (Å/min) |
| Ex. 1 | F-1 | 1 | DADMAC | 0.0025 | 4 | 3124 | 20 | 10 |
| Ex. 2 | F-1 | 1 | DADMAC | 0.005 | 4 | 3348 | 25 | 18 |
| Ex. 3 | F-1 | 1 | DADMAC | 0.01 | 4 | 3412 | 31 | 24 |
| Ex. 4 | F-1 | 1 | DADMAC | 0.02 | 4 | 3416 | 33 | 27 |
| Ex. 5 | F-1 | 1 | DADMAC | 0.05 | 4 | 3442 | 31 | 25 |
| Ex. 6 | F-1 | 2 | DADMAC | 0.01 | 4 | 3712 | 50 | 84 |
| Ex. 7 | F-2 | 1 | DADMAC | 0.01 | 4 | 3241 | 72 | 34 |
| Ex. 8 | G-1 | 1 | DADMAC | 0.01 | 4 | 3398 | 22 | 29 |
| Ex. 9 | G-1 | 1 | DADMAC | 0.01 | 11 | 3811 | 29 | 19 |
| Ex. 10 | F-1 | 1 | MTAC | 0.01 | 4 | 3361 | 41 | 29 |
| Ex. 11 | F-2 | 1 | MTAC | 0.01 | 4 | 3492 | 44 | 37 |
| Comp. | F-1 | 1 | Amide | 0.01 | 4 | 218 | 21 | 12 |
| Ex. 1 | | | | | | | | |
| Comp. | F-1 | 1 | — | — | 4 | 126 | 18 | 8 |
| Ex. 2 | | | | | | | | |
| Comp. | F-1 | 1 | P2VP | 0.01 | 4 | 234 | 32 | 14 |
| Ex. 3 | | | | | | | | |
| Comp. | F-1 | 1 | PEI | 0.01 | 4 | 1119 | 29 | 13 |
| Ex. 4 | | | | | | | | |
| Comp. | F-1 | 1 | PAA | 0.01 | 4 | 119 | 2 | 12 |
| Ex. 5 | | | | | | | | |
| Comp. | F-1 | 1 | PEG | 0.01 | 4 | 42 | 21 | 29 |
| Ex. 6 | | | | | | | | |
| Comp. | F-2 | 1 | PEG | 0.01 | 4 | 57 | 12 | 54 |
| Ex. 7 | | | | | | | | |

(1) Abrasive particles surface treatment agent
F-1: PL-3C(FUSO, cation type)
F-2: PL-1C(FUSO, cation type)
G-1: BS-1 LC(FUSO)
pH adjuster: selected from nitric acid, KOH, and triethanolamine (TEA) and each added in an amount of 0.03 wt % to 0.1 wt %.

Referring to Table 1, the polishing slurry composition according to the present disclosure may secure polishing performance of a high polishing rate for a polycrystalline silicon film in an acidic region when the quaternary ammonium cationic monomer represented by Chemical Formulae 1 and 2 is added. In other words, it can be confirmed that the polishing slurry composition according to the present disclosure may realize a high polishing rate for the polycrystalline silicon film and a high polishing selectivity for silicon oxide and silicon nitride films, in comparison to applying of a nonionic polymer, an anionic polymer, and a cationic polymer in the comparative examples.

As described above, although the embodiments have been described with reference to the limited examples and drawings, one of ordinary skill in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents. Therefore, other implementations, other embodiments, and equivalents to the claims are also within the scope of the following claims.

1. A polishing slurry composition for polishing polycrystalline silicon, the polishing slurry composition comprising:
colloidal silica abrasive particles;
a quaternary ammonium cationic monomer; and
an acidic material.

2. The polishing slurry composition of claim 1, wherein
the colloidal silica abrasive particles have cationic surface charges, and
the colloidal silica abrasive particles comprise single-sized particles with a size of 10 nanometers (nm) to 200 nm, or a mixture of two or more particles with different sizes of 10 nm to 200 nm.

3. The polishing slurry composition of claim 1, wherein the abrasive particles are in an amount of 0.0001% by weight (wt %) to 10 wt % in the slurry composition.

4. The polishing slurry composition of claim 1, wherein
the quaternary ammonium cationic monomer comprises at least one of compounds represented by the following Chemical Formulae 1 to 3: 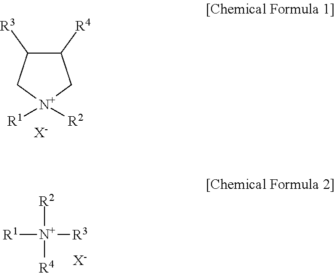
(in Chemical Formula 1, R¹ to R⁴ are each selected from a linear or branched alkyl group having 1 to 50 carbon atoms, a linear or branched alkenyl group having 2 to 50 carbon atoms, and a linear or branched alkoxyl group having 1 to 50 carbon atoms,
in Chemical Formula 2, R¹ to R⁴ are each selected from hydrogen, a linear or branched alkyl group having 1 to 50 carbon atoms, a linear or branched alkenyl group having 2 to 50 carbon atoms and a linear or branched alkoxyl group having 1 to 50 carbon atoms, and an aromatic ring having 6 to 30 carbon atoms, and
in Chemical Formulae 1 and 2, X is a counter ion and is selected from hydroxide (OH⁻), halogen, sulfate (SO₄²⁻), phosphate (PO₄³⁻), nitrate (NO₃⁻), hydrogen sulfate (HSO₄⁻), methyl methanesulfonate (CH₃SO₃⁻), perchlorate (ClO₄⁻), and hexafluorophosphate (PF₆⁻).) 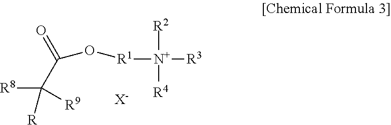
(in Chemical Formula 3, R, R⁸, and R⁹ are selected from hydrogen, a linear or branched alkyl group having 1 to 50 carbon atoms, a linear or branched alkenyl group having 2 to 50 carbon atoms and a linear or branched alkoxyl group having 1 to 50 carbon atoms, and an aromatic ring having 6 to 30 carbon atoms,
R¹ is selected from a linear or branched alkylene group having 1 to 50 carbon atoms and 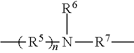
(R⁵ and R⁷ are each a linear or branched alkylene group having 1 to 50 carbon atoms, R⁶ is hydrogen, a linear or branched alkyl group having 1 to 50 carbon atoms; or a linear or branched alkenyl group having 2 to 50 carbon atoms, and n is 0 or 1),
R² to R⁴ are each selected from hydrogen, a linear or branched alkyl group having 1 to 50 carbon atoms, a linear or branched alkenyl group having 2 to 50 carbon atoms, and an aromatic ring having 6 to 30 carbon atoms, and
X is a counter ion and is selected from hydroxide (OH⁻), halogen, sulfate (SO₄), phosphate (PO₄³⁻), nitrate (NO₃⁻), hydrogen sulfate (HSO₄⁻), or methyl methanesulfonate (CH₃SO₃⁻), perchlorate (ClO₄⁻), and hexafluorophosphate (PF₆⁻).).

5. The polishing slurry composition of claim 1, wherein in Chemical Formula 1, R¹ to R⁴ are each selected from a linear or branched alkyl group having 1 to 10 carbon atoms.

6. The polishing slurry composition of claim 1, wherein
in Chemical Formula 2, R² to R⁴ are each selected from a linear or branched alkyl group having 1 to 10 carbon atoms, and
in Chemical Formula 2, at least one of R⁸ to R⁹ is hydrogen.

7. The polishing slurry composition of claim 1, wherein the quaternary ammonium cationic monomer is in an amount of 0.0001 wt % to 0.5 wt % in the composition.

8. The polishing slurry composition of claim 1, wherein
the acidic material comprises an inorganic acid, an organic acid, or both, and
the acidic material is in an amount of 0.0001 wt % to 1 wt % in the polishing slurry composition.

9. The polishing slurry composition of claim 8, wherein the inorganic acid comprises at least one selected from a group consisting of a sulfuric acid, a nitric acid, a phosphoric acid, a silicic acid, a hydrofluoric acid, a boric acid, a bromic acid, an iodic acid, a hydrochloric acid, and a perchloric acid.

10. The polishing slurry composition of claim 8, wherein
the organic acid comprises a monocarboxylic acid, a dicarboxylic acid, or both, and
the organic acid comprises at least one selected from a group consisting of a citric acid, an oxalic acid, a propionic acid, a stearic acid, a pyruvic acid, an acetic acid, an acetoacetic acid, a glyoxylic acid, a malic acid, a malonic acid, a dimethylmalonic acid, a maleic acid, a glutaric acid, an adipic acid, a 2-methyladipic acid, a trimethyl adipic acid, a pimelic acid, a phthalic acid, a trimellitic acid, a tartaric acid, a glycollic acid, a 2,2-dimethylglutaric acid, a lactic acid, isoleucine, a butyric acid, a succinic acid, a 3,3-diethylsuccinic acid, and an ascorbic acid.

11. The polishing slurry composition of claim 8, wherein, when two or more acidic materials are applied as the acidic material, a mass ratio of a first acidic material: the remaining acidic materials ranges from 9:1 to 1:9.

12. The polishing slurry composition of claim 1, wherein
the polishing slurry composition further comprises a basic compound, wherein the basic compound comprises at least one selected from a group consisting of ammonia, ammonium methyl propanol (AMP), tetramethyl ammonium hydroxide (TMAH), ammonium hydroxide, potassium hydroxide, sodium hydroxide, magnesium hydroxide, rubidium hydroxide, cesium hydroxide, sodium bicarbonate, sodium carbonate, imidazole, monoethanolamine (MEA), diethanol amine (DEA), triethanolamine (TEA), 1,5-diamino-3-pentanol, 2-dimethylamino-2-methyl-1-propanol, 1-amino-2-propanol, 1-dimethylamino-2-propanol, 1,3-diamino-2-propanol, 3-dimethylamino-1-propanol, 2-amino-1-propanol, 2-dimethylamino-1-propanol, 2-diethylamino-1-propanol, 2-(2-aminoethylamino) ethanol, 2-diethylamino-1-ethanol, 2-ethylamino-1-ethanol, 1-(dimethylamino) 2-propanol, N-methyldiethaolamine, N-propyldiethaolamine, N-isopropyldiethaolamine, N-(2-methylpropyl) diethaolamine, N-n-butyldiethaolamine, N-t-butylethanolamine, N-cyclohexyldiethaolamine, 2-(dimethylamino) ethanol, 2-diethylaminoethanol, 2-dipropylaminoethanol, 2-butylaminoethanol, 2-t-butylaminoethanol, 2-cycloaminoethanol, 2-amino-2-pentanol, 2-[bis(2-hydroxyethyl)amino]-2-methyl-1-propanol, 2-[bis(2-hydroxyethyl)amino]-2-propanol, N,N-bis(2-hydroxypropyl) ethanolamine, 2-amino-2-methyl-1-propanol, tris(hydroxymethyl)aminomethane, triisopropanolamine, tetraethyl ammonium hydroxide (TEAH), tetrapropylammonium hydroxide (TPAH), tetrabutylammonium hydroxide, tetrapentylammonium hydroxide (TBAH), methyl(trishydroxyethyl) ammonium hydroxide, tributylethylammonium hydroxide, (2-hydroxyethyl), triethylammonium hydroxide, (2-hydroxyethyl) tripropylammonium hydroxide, and (1-hydroxypropyl) trimethylammonium hydroxide.

13. The polishing slurry composition of claim 1, wherein pH of the slurry composition ranges from 2 to 11.

14. The polishing slurry composition of claim 1, wherein a polishing speed of the polishing slurry composition for a polycrystalline silicon film is 2000 Å/min or greater.

15. The polishing slurry composition of claim 1, wherein, in pH of 3 to 5 or pH of 9 to 11 of the polishing slurry composition, a selectivity of a polycrystalline silicon film: a film comprising a silicon nitride film, a silicon oxide film, or both ranges from 10:1 to 1000:1.
